(19) United States
(12) Patent Application Publication
(10) Pub. No.: US 2017/0215395 A1
(43) Pub. Date: Aug. 3, 2017

(54) CHILD-FRIENDLY EXPANDABLE FISH HOOK ASSEMBLY

(71) Applicant: Andrew Offrink, Olivet, MI (US)

(72) Inventor: Andrew Offrink, Olivet, MI (US)

(21) Appl. No.: 15/416,587

(22) Filed: Jan. 26, 2017

Related U.S. Application Data
(60) Provisional application No. 62/290,598, filed on Feb. 3, 2016.

(51) Int. Cl. A01K 83/02; A01K 83/04; A01K 85/00

(52) U.S. Cl. CPC A01K 83/02; A01K 85/00; A01K 83/04

(57) ABSTRACT

An expandable fish hook assembly includes a central shaft having one end attached to a fishing line and a plurality of arms or hook members pivotably coupled at or near the other end of the central shaft. The plurality of arms or hooks pivot between a collapsed position, with each arm or hook generally adjacent the central shaft, and a deployed position, with each arm or hook generally angled away from the central shaft. A sliding member engages the central shaft and moves along the central shaft, whereby the sliding member also operatively engages and moves along each of the plurality of arms to support and move the arms between the collapsed and deployed positions.

### CROSS REFERENCE TO RELATED APPLICATION

The present application claims the filing benefit of U.S. provisional application, Ser. No. 62/290,598, filed Feb. 3, 2016, which is hereby incorporated herein by reference in its entirety.

### FIELD OF THE INVENTION

The present invention relates generally to the field of fishing hooks and lures.

### BACKGROUND OF THE INVENTION

Fish hooks and lures with exposed hooks or barbs can be dangerous for children and individuals inexperienced with angling to handle and cast with a fishing rod, as the exposed hooks can move or swing in undesirable directions, and as a result, can become lodged or otherwise snagged in harmful or injurious locations.

### SUMMARY OF THE INVENTION

The present invention provides an expandable fish hook assembly with a set of hooks or arms or the like that remain collapsed for handling and casting, and when taken by a fish, pivot or expand away from a central member or shaft for allowing the fish to be caught. In accordance with one aspect of the present invention, the expandable fish hook assembly includes a central shaft having one end attached to a fishing line and a plurality of arms or hook members pivotably coupled at or near the other end of the central shaft. The plurality of arms or hook members pivot between a collapsed position, with each arm or hook member generally adjacent the central shaft, and a deployed position, with each arm or hook member generally angled away from the central shaft, such as angled perpendicular to the central shaft. A sliding member is movable along the central shaft, whereby retention features on the sliding member operatively engage and move along each of the plurality of arms or hook members to move and support the arms or hook members in the collapsed and deployed positions.

In accordance with another aspect of the expandable fish hook assembly, a spring can be coupled between the central shaft and the sliding member to bias the sliding member toward the end of the central shaft attached to the fishing line, such that when the sliding member is moved toward the fishing line end of the central shaft, the arms or hook members are moved toward the collapsed position, and when the sliding member is moved against the spring bias toward the opposing end of the central shaft, the arms or hooks are moved toward the expanded position. Thus, the spring can bias the arms or hooks toward the collapsed position.

In accordance with yet another aspect of the expandable fish hook assembly, the retention features on the sliding member may engage a guide element that is optionally included on an inside portion of each of the plurality of arms to facilitate the sliding engagement and movement of the retention features on each of the arms or hooks. Further, each of the plurality of arms or hook members may optionally include a holding surface, such as a bend or offset surface in the guide element, that engages the retention features when the sliding member is moved toward the end of the central shaft pivotably coupled with the arms or hooks to hold or lock the arms or hook members in a desired position, such as the expanded or deployed position.

In accordance with another aspect of the expandable fish hook assembly, each of the plurality of arms or hook members may include a main portion that has an arcuate shape protruding away from the central shaft with the arms in the collapsed position and a distal end portion that has an oppositely curved tip protruding away from the central shaft with the arms or hook members in the collapsed position. The curved tip may optionally be generally blunt to prevent injuries when handling and casting, with its curvature protruding away from the central shaft to still permit a fish's mouth to engage the tip, and thereby allow force on the fishing line to move the arms or hook members to pivot to the expanded position inside the mouth of the fish, further engaging the fish to allow it to be caught.

These and other objects, advantages, purposes and features of the present invention will become apparent upon review of the following specification in conjunction with the drawings.

### BRIEF DESCRIPTION OF THE DRAWINGS

FIG. 1 is a perspective view of an expandable fish hook assembly, in accordance with one embodiment the present invention;

FIG. lA is a side cross-sectional view of the expandable fish hook assembly of FIG. 1, illustrating hook arms in a collapsed position;

FIG. 2 is a side elevational view of the expandable fish hook assembly of FIG. 1, illustrating hook arms in an expanded or deployed position;

FIG. 3 is an exploded perspective view of some components of the expandable fish hook assembly of FIG. 1;

FIG. 4 is a side elevational view of a central shaft shown in FIG. 3;

FIG. 5 is another side elevational view of the central shaft shown in FIG. 3;

FIG. 6 is a side elevational view of a base member shown in FIG. 3;

FIG. 6A is a cross-sectional view of the base member, taken at line A-A shown in FIG. 6;

FIG. 7 is a top plan view of the base member shown in FIG. 3;

FIG. 8 is an exploded perspective view of a hook arm of the expandable fish hook assembly of FIG. 1;

FIG. 9 is a side elevational view of the hook arm shown in FIG. 8;

FIG. 9A is a cross-sectional view of the hook arm, taken at line A-A shown in FIG. 9;

FIG. 10 is a perspective view of a sliding member of the expandable fish hook assembly of FIG. 1;

FIG. 11 is a side elevational view of the sliding member shown in FIG. 10;

FIG. 11A is a cross-sectional view of the sliding member, taken at line A-A shown in FIG. 11; and

FIG. 12 is a bottom plan view of the sliding member shown in FIG. 10.

### DESCRIPTION OF THE PREFERRED EMBODIMENTS

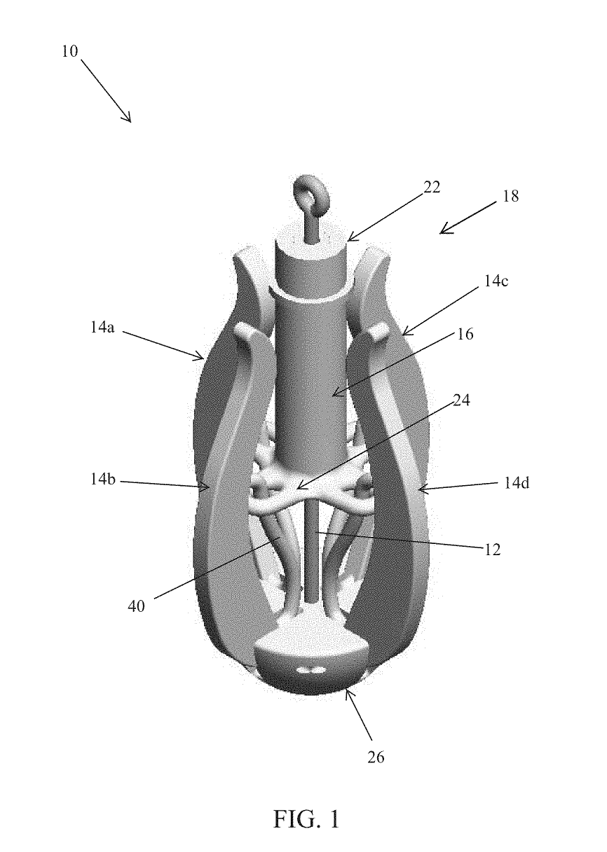

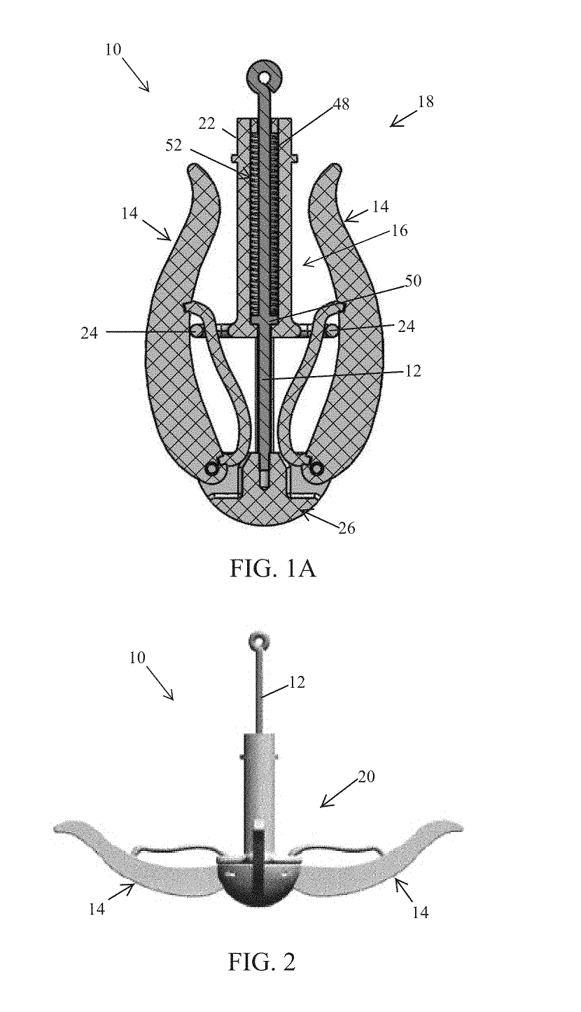

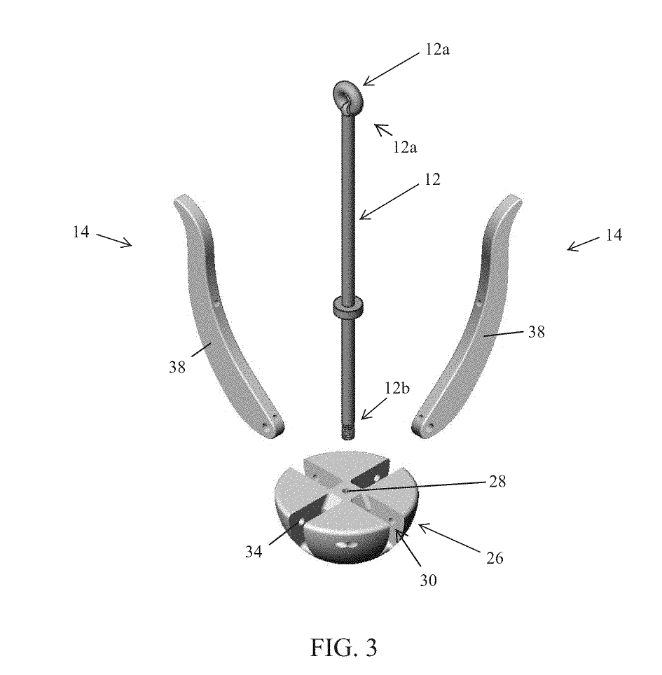

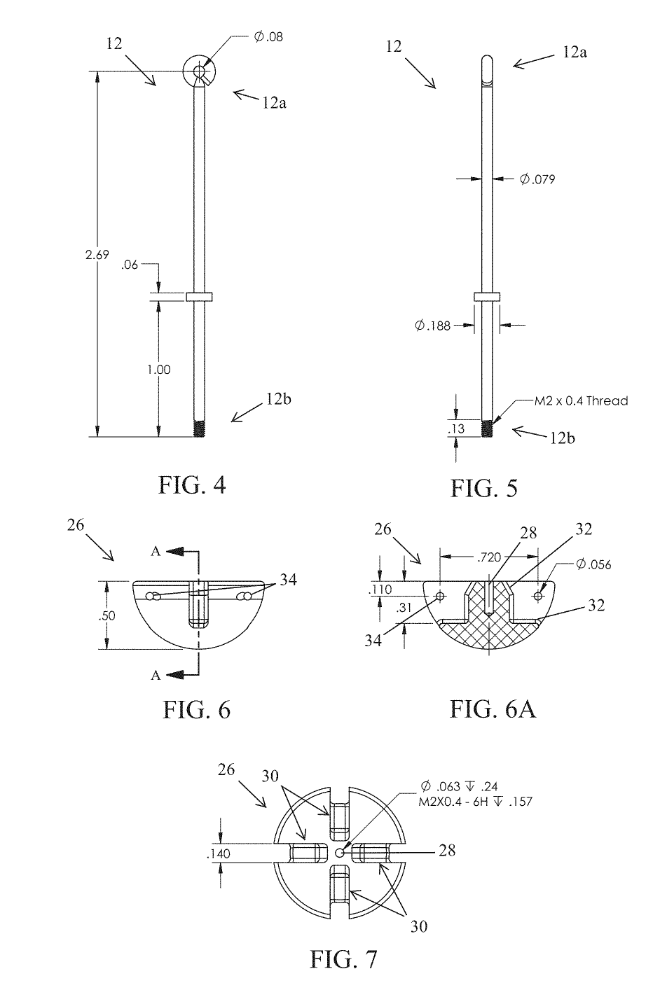

Referring now to the drawings and the illustrative embodiments depicted therein, an expandable fish hook assembly 10 includes a central shaft 12, moveable hook arms 14, and a hook retention device 16 that together allow the fish hook assembly 10 to be handled and cast in a generally safe, collapsed condition, such as shown in FIG. 1. Once consumed in a fish's mouth, the fish hook assembly 10 may move to the expanded condition, as shown for example in FIG. 3, whereby the fish hook assembly 10 is sized and arranged to prevent withdrawal from the fish's mouth, so that the fish may be pulled and reeled in by the fishing line, while generally preventing significant damage or injury to the fish's mouth and gills.

In the illustrated example, the hook arms 14 each pivot about a base end of the central shaft 12 between a collapsed position 18 (FIG. 1), with each hook arm 14 generally adjacent the central shaft 12, and a deployed position 20 (FIG. 2), with each hook arm 14 generally angled or cantilevered away from the central shaft 12, thereby assuming the expanded condition of the fish hook assembly 10. It is understood that the collapsed position 18 may optionally include the arms 14 abutting the central shaft 12 or otherwise spaced further away from the central shaft 12 from that illustrated in FIG. 1. Similarly, the expanded or deployed position 20 may optionally include the arms 14 positioned at various angles spaced from the central shaft 12, including being generally perpendicular to the central shaft 12 as shown in FIG. 2 and being at other angles that are generally less than perpendicular to the central shaft 12, such as to avoid providing an angle substantially greater than perpendicular to the shaft 12 that may provide a ramped surface that would allow the arms to be easily removed from a fish's mouth.

The hook retention device 16 in the illustrated example of the expandable fish hook assembly 10 provides a sliding member 22 that moves along the central shaft 12 and interfaces with the hook arms 14 to move and support the hook arms 14 in the collapsed and deployed positions 16, 18. More specifically, the sliding member 22 may be provided with retention features 24 that protrude from the body portion of the sliding member 22 and operatively engage each of the plurality of arms 14, such as at an inside portion of each arm 14. However, it is contemplated that the hook retention device in additional embodiments may be alternatively integrated with the hook arms or the central shaft within the scope of the present invention.

The central shaft 12 includes a rigid, elongated member having one end portion 12a adapted to be attached to a fishing line, as shown in FIG. 3 as a metal rod with an eyelet formed at the end 12a of the shaft 12. The plurality of hook arms 14 are pivotally coupled at or near the opposing base end portion 12b of the central shaft 12 in a manner that allows movement of the arms 14 between the collapsed and deployed positions. As also shown in the embodiment illustrated in FIG. 3, a base housing or member 26 is securely attached to the base end portion 12b of the central shaft 12 to provide pivotal locations for the base ends of the plurality of hook arms 14. It is, however, understood that the plurality of arms may optionally be directly attached to the central shaft in a pivotal manner in additional embodiments of the expandable fish hook assembly. The base end portion 12b of the central shaft 12 is illustrated with a threaded section that is configured to screw into and threadably engage a central hole 28 on the base member 26, thereby forming a secure connection. In addition or in the alternative to a threaded connection, the attachment between the central shaft 12 and the base member 26 in additional embodiments may optionally be formed with adhesive, heat welding, friction welding, insert molding, and other conceivable forms of connection. It is also contemplated that the base member may optionally be integrally formed with the central shaft, such as formed as a single piece by injection molding with a substantially rigid polymer.

The base member 26 may provide pivotal attachment locations for each of the plurality of arms 14 to pivot between the collapsed and deployed positions 16, 18. The illustrated base member 26 provides a pivotal axis for each of the plurality of arms 14 that is perpendicular to and spaced from a longitudinal extent of the central shaft 12. The pivotal attachment locations shown on the base member 26 are each defined by a recess 30 in the generally planar, upward facing surface of the base member 26, with each recess 30 extending radially inward from the outer edge or circumference of the base member 26 toward the central shaft 12. The recesses 30 each provide space for the base end of the arm 14 to pivot between the collapsed and deployed positions 16, 18. Optionally, the recesses 30 may also include stop surfaces 32 (FIG. 6A) at opposing ends of each recess 30 that are formed to abut opposing sides or bottom portions of the arm 14 when pivoted to the collapsed and deployed positions, limiting further pivotal movement of the associated arm.

The base member 26, as shown for example in FIGS. 6-7, may have a semi-spherical shape with a generally planar upper surface and a rounded surface facing downward away from the central shaft 12. In additional embodiments, the base member may have different shapes and configurations, such as a downward pointing conical shape, a minnow tail shape, or other conceivable shapes that may be desired for a fishing lure. Holes 34 are provided in the base member 26 for containing pivot pins that extend through the base or pivot ends of the arms 14 and may be provided through the edge portions of the base member 26, such as shown in FIG. 7 oriented as arcs of the circular-shaped upper surface of the illustrated base member 2, whereby the pins are generally perpendicular to each other. Accordingly, the holes 34 extend through the recesses 30 to each define the pivotal axis for the respective hook arm 14.

The expandable fish hook assembly 10 may optionally include any number of arms or hooks members pivotally coupled with the central shaft 12, although having at least two opposing arms or at least three circumferentially spaced arm is preferred for expanding the fish hook assembly in a manner that substantially increases a dimension of the expanded assembly to prevent the expanded assembly from exiting a fish's mouth while the fish is being caught. The plurality of arms 14 or hooks members illustrated in the embodiment provided in FIG. 1 include four separate arms or hook members 14a, 14b, 14c, 14d pivotally coupled at or with the base member 26. It is also understood that the arms or hook members may have various shapes and sizes to similarly be adapted or otherwise selected, along with other components of the fish hook assembly, to catch a particular type or size of fish.

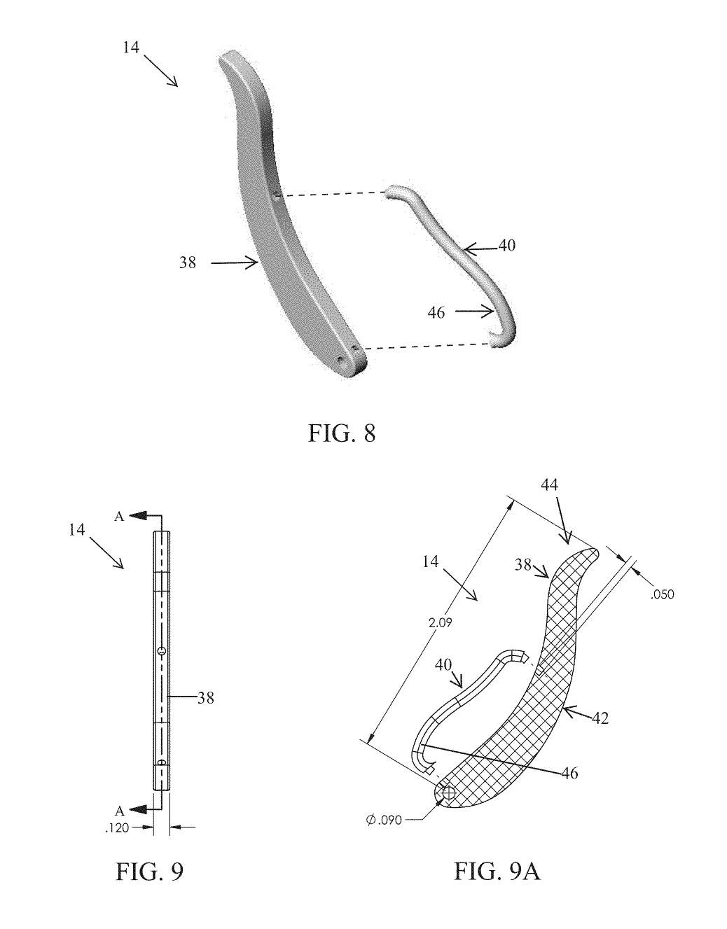

In the examples illustrated in FIGS. 8 and 9A, the arms or hook members 14 each include a main wing portion 38 attached to a guide portion 40 that extends along and partially defines an inside section of the arm or hook member 14. The main wing portion 38 may be shaped to have a central section 42 that includes an arcuate profile, shown for example in FIG. 1A, protruding away from the central shaft 12 when the arms 14 are in the collapsed position. The main wing portions 38 of the arms 14, such as shown in FIG. 9A, may also have a distal end portion 44 that has an oppositely curved tip from the main portion, which generally curves and protrudes away from the central shaft 12 when the arms 14 are pivoted to the collapsed position. The curved tip may optionally have a blunt end, without a sharp edge as shown, to further prevent injuries when handling and casting the expandable fishing hook assembly. The curvature of the distal end potion 44 that protrudes from the central shaft may expose the curved tip and still permit a fish to engage the tip, thereby allowing the downward force on the tip to counteract the support of the fishing line to pivot the arms or hook member 14 downward or otherwise away from the central shaft 12 to the expanded position inside the mouth of the fish.

The illustrated arms 14 are each individually engaged and supported by the sliding member 22 of the hook retention device 16. The sliding member 22, as shown for example in FIG. 1A, moves along the central shaft 12, whereby the retention features 24 on the sliding member 22 operatively engage and move along each of the plurality of arms 14, such as along the guide portion 40 of each arm, to move and support the arms 14 in the collapsed and deployed positions. The retention features 24 on the sliding member 22 may engage the guide portion 40, such as shown in FIG. 1A, which is optionally included on an inside portion of each of the plurality of arms 14 to facilitate the sliding engagement, movement, and support of the retention features 24 on each of the arms or hook members. In the example illustrated in FIGS. 8 and 9A, the guide portion 40 is shown as a separate member exploded away from the main wing portion 42 of the arm 14. As such, the guide portion 40 is securely attached to the main wing portion 42, such as with adhesive, welding, friction fitting, or other connection methods. It is conceivable that the guide portion may optionally be integrated with the main wing portion 42 as a single integral piece or part and may optionally be differently shaped, such as an outward rail or inward groove on the inside surface of the main wing portion 42, thereby defining a section of the inside portion of the arm 14 for providing slidable engagement.

The illustrated retention features 24 radially protrude from a base end portion of the sliding member 22 and each provide an aperture that is slidably engaged by a guide element on an inside portion of each of the plurality of arms. It is contemplated that the slidable engagement between the hook arms 14 and the sliding member 22 of the hook retention device may, in additional embodiments, be provided by other forms of movable connectors or assemblies.

Optionally, the inside portion of the arm 14 may include a holding or ramped surface 46, such as a bend or offset surface in the guide element, that engages the retention features 24 when the sliding member 22 is moved toward the end of the central shaft near the pivotal locations of the arms or hook members to hold or lock the arms or hook members in the expanded or deployed position. To facilitate the engagement of the holding surface 46, in the illustrated embodiment shown in FIGS. 8 and 9A, the guide portion 40 has a curved elongated element with a cylindrical or tubular shape, which is curved at the end of the guide portion 40 near the pivotal location of the arm 14 in an oppositely curved or angled manner to form and at least partially define the illustrated holding surface 46.

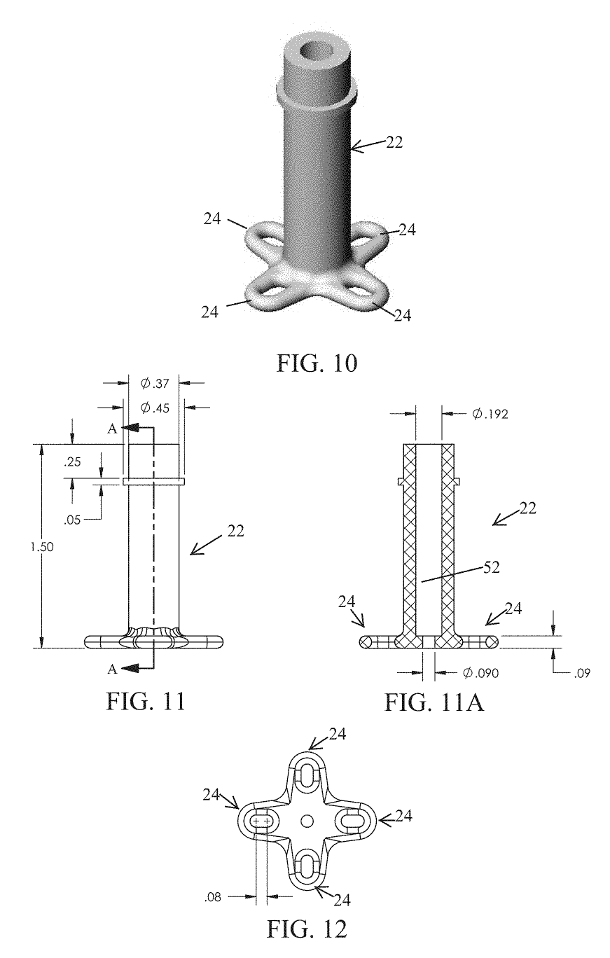

The retention device may also include a spring 48 coupled between the central shaft 12 and the sliding member 22 to bias the sliding member 22 relative to the central shaft. As shown in FIG. 1A, the spring 48 engages between a lateral protrusion or radially protruding member 50 on the central shaft 12 and an upper surface of an interior cavity 52 on the sliding member 22 to biases the sliding member 22 toward the end of the central shaft attached to the fishing line. The upper surface of the interior cavity 52 may be defined by a cap that is securely attached to the body portion of the sliding member upon assembly of the sliding member on the central shaft 12, whereby that the cap is not shown in FIGS. 10-12. As such, when the sliding member 22 is moved via the biasing force of the spring 48 toward the fishing line end of the central shaft, the arms or hook members 14 are moved toward the collapsed position. And, similarly, when the sliding member 22 is moved toward the opposing end of the central shaft 12, the arms or hook members 14 are moved toward the expanded position. Thus, the illustrated retention device 16 biases the arms or hooks toward the collapsed position. The interior cavity on the illustrated sliding member 22 is arranged coaxially with the central shaft 12 and has a depth that substantially conceals the coil spring 48 disposed about the central shaft 12. It is contemplated that the spring of the retention device may be various types of springs or biasing elements to similarly bias the arms or hook members toward one of the collapsed or expanded positons.

Once the arms or hook members have moved to the expanded position, such as within a fish's mouth after an angler has reeled in the fish, a hand-held removal device may be used to dislodge the retention features from the holding surface on the inside portion of the arms and allow the slider member to draw the arms back to the collapsed position, such as for removing the fish hook assembly form the fish's mouth. For example, the removal device may include a plunger tool that has a first portion to engage the central shaft and a second portion to engage the sliding member, such that the removal device may actuate the first and second portions to move relative to each other for collapsing the arms. Such a removal device may be configured for use with a single hand, for easily withdrawing the hook assembly from the mouth of a fish.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

For purposes of this disclosure, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

Changes and modifications in the specifically-described embodiments may be carried out without departing from the principles of the present invention, which is intended to be limited only by the scope of the appended claims as interpreted according to the principles of patent law including the doctrine of equivalents.

1. An expandable fish hook assembly comprising:
a plurality of arms pivotable between a collapsed position with distal ends of the plurality of arms generally adjacent each other and a deployed position with the plurality of arms angled outward with the distal ends spaced away from each other for lodging in a fish's mouth; and
a hook retention device configured to move along each of the plurality of arms to support the plurality of arms when moving from the collapsed position to the deployed position, wherein the hook retention device is configured to hold the plurality of arms in the deployed position.

2. The expandable fish hook assembly of claim 1, wherein the hook retention device engages and moves along an intermediate portion of each of the plurality of arms.

3. The expandable fish hook assembly of claim 1, wherein an opposing end of each of the plurality of arms are pivotally coupled with a central shaft configured to attach to a fishing line.

4. The expandable fish hook assembly of claim 3, wherein the collapsed position includes each of the plurality of arms generally adjacent the central shaft and the deployed position includes each of the plurality of arms extending substantially perpendicular from the central shaft.

5. The expandable fish hook assembly of claim 3, wherein the hook retention device includes a sliding member movably engaged with the central shaft, and wherein the sliding member engages and moves along the intermediate portion of each of the plurality of arms.

6. The expandable fish hook assembly of claim 5, further comprising a spring coupled between the central shaft and the sliding member to bias the sliding member toward a first end portion of the central shaft with the plurality of arms supported in the collapsed position.

7. The expandable fish hook assembly of claim 5, wherein the sliding member includes retention features that radially protrude outward from the central shaft and slidably engage a guide element on an inside portion of each of the plurality of arms.

8. The expandable fish hook assembly of claim 1, wherein each of the plurality of arms includes a holding surface that is configured to engage the hook retention device to hold the plurality of arms in the deployed position.

9. An expandable fish hook assembly comprising:
a central shaft having a first end portion configured to attach to a fishing line;
a plurality of arms pivotably coupled at or near an opposing second end portion of the central shaft, wherein the plurality of arms are pivotable from a collapsed position with each of the plurality of arms generally adjacent the central shaft to a deployed position with each of the plurality of arms angled away from the central shaft; and
a sliding member engaged with the central shaft and movable on the central shaft between the first and second end portions, wherein the sliding member includes retention features that engage and move along each of the plurality of arms for supporting the plurality of arms in the collapsed and deployed positions.

10. The expandable fish hook assembly of claim 9, further comprising a spring coupled between the central shaft and the sliding member to bias the sliding member toward the first end portion of the central shaft to bias the plurality of arms toward the collapsed position.

11. The expandable fish hook assembly of claim 9, wherein when the arms are moved toward the deployed position, the sliding member is moved toward the opposing second end portion of the central shaft.

12. The expandable fish hook assembly of claim 9, wherein each of the plurality of arms include a holding surface that engages the retention features when the sliding member is moved toward the second end portion of the central shaft to hold the plurality of arms in the deployed position.

13. The expandable fish hook assembly of claim 9, wherein the retention features of the sliding member protrude radially outward away from the central shaft and each slidably engage a guide element on an inside portion of each of the plurality of arms.

14. The expandable fish hook assembly of claim 13, wherein the guide elements each include a sliding portion and a holding portion, wherein the retention features are movable on the sliding portion of the guide elements when the plurality of arms move toward the deployed position, and wherein the retention features engage the holding portion of the guide elements to lock the plurality of arms in the deployed position.

15. The expandable fish hook assembly of claim 9, wherein each arm of the plurality of arms includes an arcuate shape protruding away from the central shaft with the arms in the collapsed position.

16. The expandable fish hook assembly of claim 9, wherein each arm of the plurality of arms includes a distal end portion that has a curved tip protruding away from the central shaft and configured to engage a fish's mouth.

17. The expandable fish hook assembly of claim 9, further comprising a base member coupled to the second end portion of the central shaft and having pivotal attachment locations for engaging the plurality of arms, wherein the base member includes a rounded surface facing away from the second end portion of the central shaft.

18. The expandable fish hook assembly of claim 9, further comprising a coil spring disposed about the central shaft and engaged between the sliding member and an intermediate portion the central shaft, and wherein the sliding member includes an interior cavity that substantially conceals the coil spring.
